(19) United States
(12) Patent Application Publication
(10) Pub. No.: US 2014/0158645 A1
(43) Pub. Date: Jun. 12, 2014

(54) System and Method Related to a Storage and Retrieval Device for Clasping Mechanisms

(71) Applicant: Thomas Concepts, LLC, Dallas, TX (US)

(72) Inventor: Steven H. Thomas, Dallas, TX (US)

(73) Assignee: Thomas Concepts, LLC, Dallas, TX (US)

(21) Appl. No.: 13/958,457

(22) Filed: Aug. 2, 2013

Related U.S. Application Data
(60) Provisional application No. 61/679,533, filed on Aug. 3, 2012.

(51) Int. Cl. B43M 99/00

(52) U.S. Cl. CPC B43M 99/009
USPC 211/13.1

(57) ABSTRACT

The present invention is a storage and retrieval device for binder clip mechanisms and comprises a cluster of extended plastic posts protruding outward from a surface in such a manner to allow a binder clip mechanism to easily grip one or more of the extended plastic posts quickly and easily and without the necessity of the user selecting any particular post.

### RELATED APPLICATION DATA

This application is related to Provisional Patent Application Ser. No. 61/679,533 filed on Aug. 3, 2012 entitled “Storage and Retrieval Device of Clasping Mechanisms.” Priority is claimed for these earlier filings under 35 U.S.C. §119(e), and the Provisional patent application is also incorporated by reference into this utility patent application.

### TECHNICAL FIELD

The invention relates to a storage and retrieval device for paper clasping and binding mechanisms.

### BACKGROUND OF THE INVENTION

Currently there are a number of different clipping and clasping devices of various sizes, shapes and uses available to the public, such as binder clips, magnetic clips, workbench clamps, hemostats, wire clamps, lapel clamps for name tags, clothes pins, and many others. Binder clips and paper clips are normally transported in small boxes or plastic containers, like many other office supplies. Clip holders have included circular vessels made from stamped metal or wire mesh, and these clip holders can be stacked on top of each other to conserve space on an office desk.

Magnetic binder and paper clip holders have also been produced that possess an aperture surrounded by magnetic elements. These types of holders may be shaped in a box, tray or cylinder design, and apertures can be placed in a circular, triangular or rectangular shapes on the holder body. Magnetic elements can surround the opening or an aperture on the container, which assists in keeping the clips organized and more accessible to the office worker.

Many of these containers are composed of multiple parts, including a body structure and a lid or top portion of the container. These multiple part containers are cumbersome, and sometimes these multiple parts of the container come apart when paper and binder clips are accessed in the container. What is needed is a single body modular clip holder than does not possess multiple parts or the need for expensive magnetic elements.

The existing containers often present the paper and binder clips in an unorganized fashion grouped all together in a mass of intertwined clips, which makes it difficult to access a single clip when it is needed by the user. Binder clips generally have a gripping end and handle or lever means for causing the gripping end to grasp or release a work piece. The user actuates gripping of the binder clip by exerting pressure on handles or levers to cause either a clasping or releasing reaction of the gripping end.

When binder and paper clips are massed together in an unorganized fashion, they often get tangled together. Storage of binder clip mechanisms in a neat and convenient manner can be challenging due to the size and shape of said mechanisms, and there is a need to present paper and binder clips to the user in an organized and segregated fashion with the grasping portions of the binder clips being easily accessible.

### SUMMARY OF THE INVENTION

In the present invention, the storage and retrieval device holds paper and binder clip devices and comprises a cluster of extended plastic posts protruding outwardly from a base surface in such a manner to allow a binder clip to grip one or more of the extended plastic posts quickly and easily, without the necessity of the user selecting any particular post or position on the container. Moreover, the storage and retrieval device has a reservoir or well that holds paper clips, clips, or other assorted items (e.g. coins, tokens, etc.).

The cluster format for the extended plastic posts may include any number of extended posts spaced relatively equidistant from one another. Moreover, the number of extended plastic posts should be sufficient to allow for storage of a sufficient number of the binder clips such that the storage device will prove efficient in the context of use.

The extended plastic posts may include a two stage structure where the lower portion of the post has a predetermined diameter, and the upper portion of the post has a diameter much less than the predetermined diameter. The post is topped with a semi-circular end for ease of use, and the shape of the extended post may be circular, rectangular, square, octagonal, or any other geometric shape so long as the thickness of the post and shape allow it to stand upright under normal conditions, and to withstand the stress of being gripped by the binder clip mechanism without breaking. The extended plastic posts should be long enough to permit easy gripping by the binder clip mechanism.

Generally, the extended plastic posts are made of flexible material, but the need for, or degree of; flexibility will depend upon the type of binder clip mechanism for which the particular storage device is designed. In a preferred embodiment, the base surface from which the extended plastic posts protrude is planar, but the surface could have a nonplanar contour such as hemispherical, pyramidical, or with other geometric shapes or designs that permit the extended plastic posts to protrude upward and/or outward for access by the user. The surface may also be circular, spherical, egg shaped, cylindrical or otherwise designed to employ a 360 degree user field that would turn on an axis so that all 360 degrees could be accessed by the user.

### BRIEF DESCRIPTION OF THE DRAWINGS

For a more complete understanding of the present invention, and for further details and advantages thereof, reference is now made to the following Detailed Description taken in conjunction with the accompanying drawings, in which:

FIG. 1 is a perspective view of a storage and retrieval device according to one embodiment of the present invention;

FIG. 2A is a top view of the storage and retrieval device shown in FIG. 1;

FIG. 2B is a right side view of the storage and retrieval device shown in FIG. 1;

FIG. 2C is a left side view of the storage and retrieval device shown in FIG. 1;

FIG. 2D is a front view of the storage and retrieval device shown in FIG. 1;

FIG. 2E is a rear view of the storage and retrieval device shown in FIG. 1;

FIG. 3 is a partial side view illustrating the posts of an embodiment of the storage and retrieval device;

FIG. 4A is a perspective view of an alternate embodiment of a storage and retrieval device;

FIG. 4B is a perspective view of an alternate embodiment of a storage and retrieval device;

FIG. 5A is a perspective view of an alternate embodiment of a storage and retrieval device;

FIG. 5B is a perspective view of an alternate embodiment of a storage and retrieval device;

FIG. 6A is a perspective view of an alternate embodiment of a storage and retrieval device;

FIG. 6B is a perspective view of an alternate embodiment of a storage and retrieval device;

FIG. 7A is a perspective view of an alternate embodiment of a storage and retrieval device;

FIG. 7B is a perspective view of an alternate embodiment of a storage and retrieval device.

### DETAILED DESCRIPTION

The present invention is directed to a system and method of making a storage and retrieval device for various binder and paper clip devices, as well as other items. These clip devices range from binder clips, magnetic clips, work bench clamps, hemostats, wire clamps, lapel clamps for name tags, close pin clamps and the like. The present invention is fabricated with a high-density plastic composition. In order to make the present invention, the manufacturer will need high density liquid plastic, a heat source and heating vessel, a thermometer, coloring, a mold configured to imitate the shape and size of the storage and retrieval device.

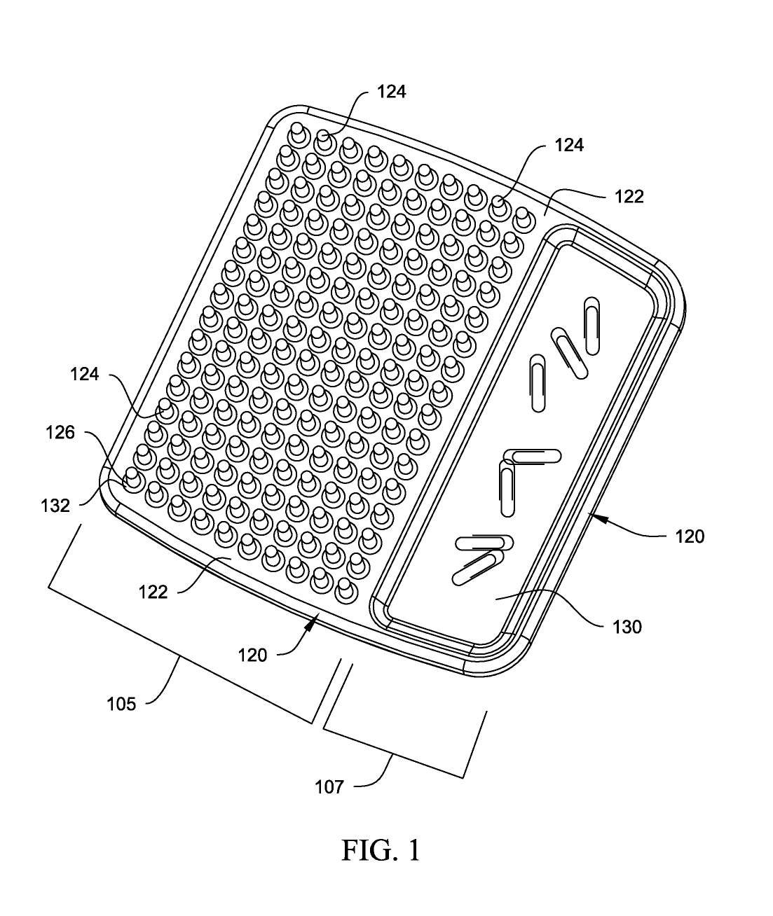

Referring to FIG. 1, the storage and retrieval device comprises a base 120, having an upper base surface 122 and a bottom base surface on the opposing side of base 120 from the upper base surface 122. The upper base surface 122 has a post portion 105 and a recess portion 107. Base 120 is a planar shape. Post portion 105 has a plurality of extended plastic posts 124 that are integrally formed or attached to the upper base surface 122 and extend perpendicularly outward from upper base surface 122.

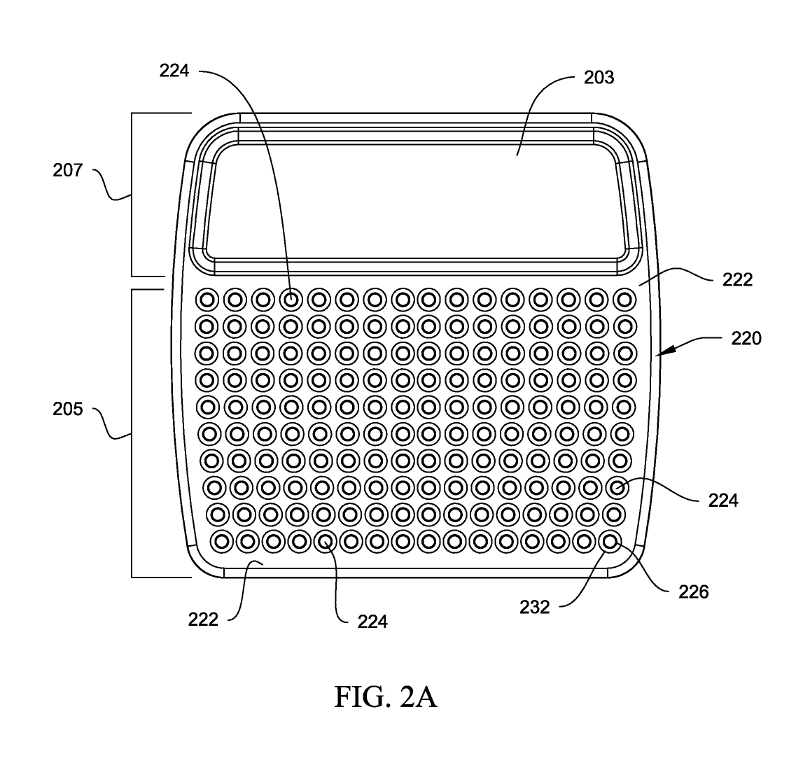

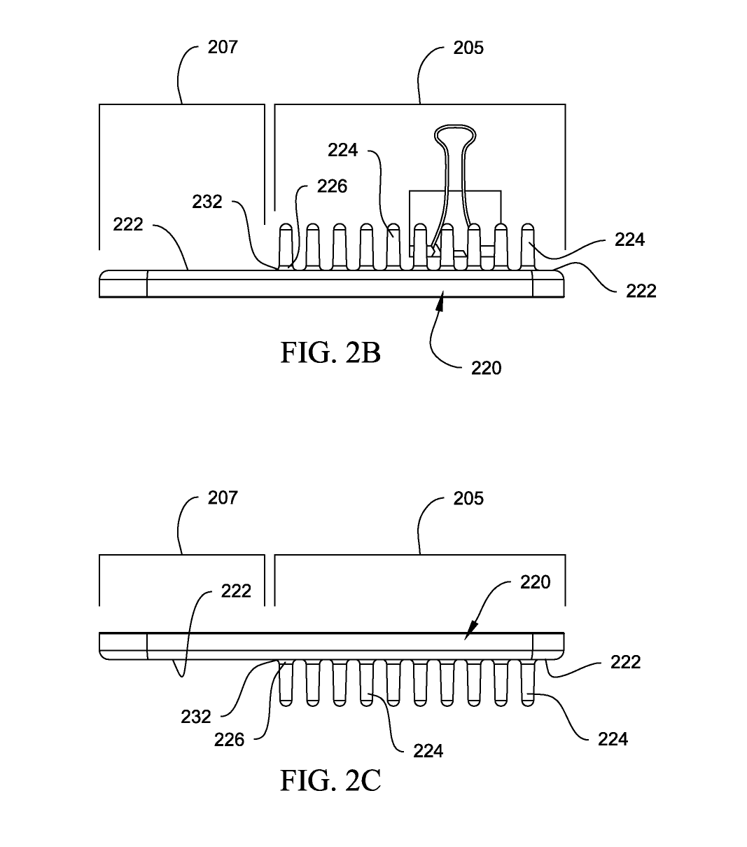

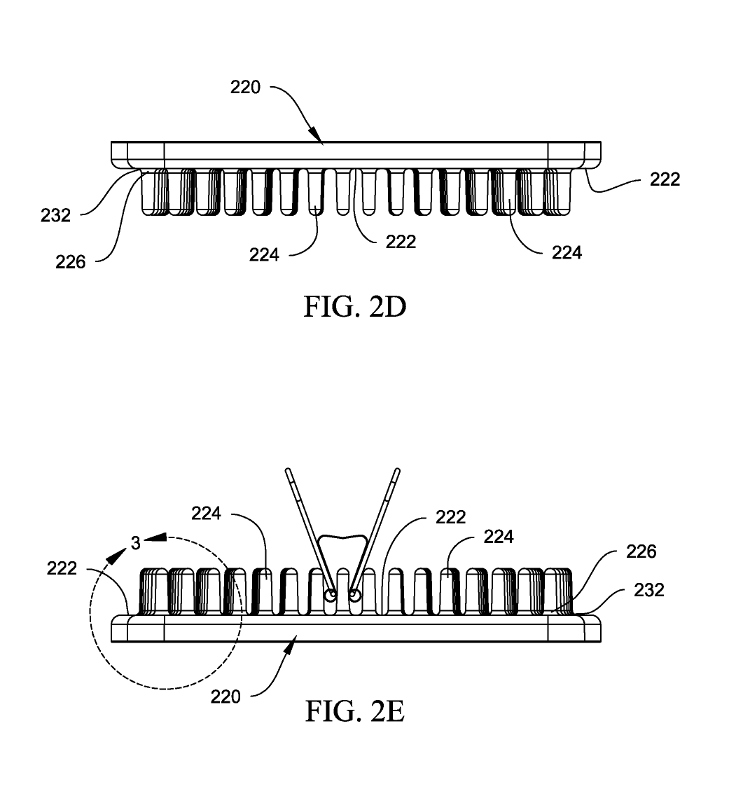

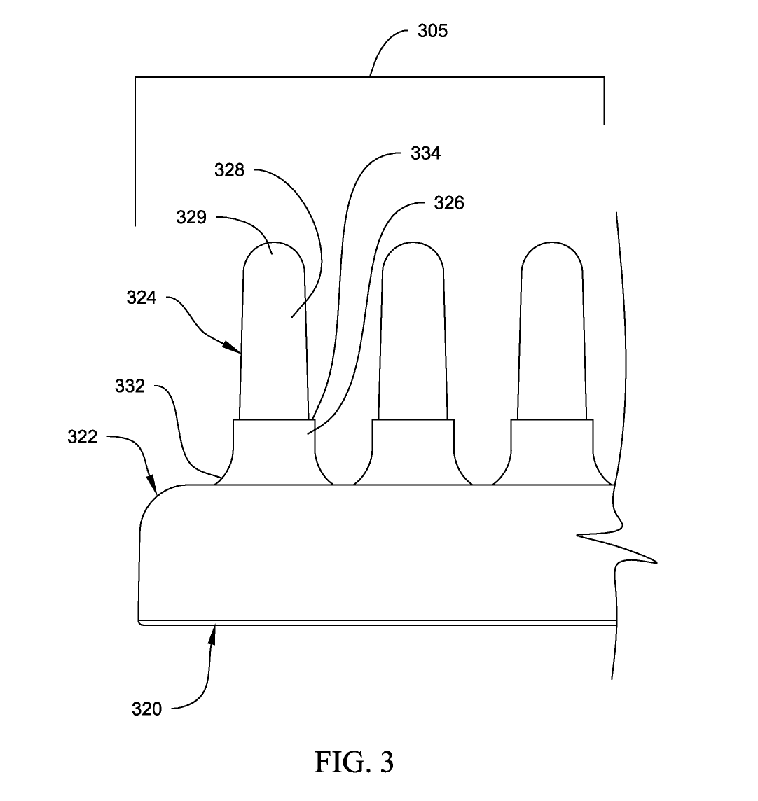

To provide additional strength, a fillet 132 may be integral with the device at the junction between the post base 126 and the base 120 (as best shown in FIG. 3). Extended plastic posts 124 are positioned in a cluster format on base 120 and may be placed in rows and columns spaced such that the separation between rows and column are of relatively equal distance. This orientation is best viewed in the top view illustrated in FIG. 2A.

With regard to the dimensions of the present invention, in one form of the invention, the base has a dimension of 106 mm by 152 mm. The extended plastic posts are positioned in a matrix of ten extended plastic posts by sixteen extended plastic posts with a spacing between extended plastic posts of 7.5 mm. Post spacing may be adjusted as necessary. Each post is 17 mm in length from the base connection to the hemispherical tip and is filleted at the base for additional strength. The fillet has a radius of 1.4 mm. The diameter of the pin just above the fillet is 7.6 mm and gradually tapers to 6 mm as it transitions into the hemispherical tip. There is a step reduction in the diameter of the base. The thickness of base is 6.5 mm and may be honeycombed to reduce the material required for construction.

Although a preferred embodiment provides for the equal distance spacing of extended plastic posts 124, equal distance positioning of the extended plastic posts is not essential to the proper operation of the present invention. Moreover, the number of extended plastic posts may be increased or decreased to provide for sufficient storage of an appropriate number of binder clip mechanisms such that the storage device proves sufficient for the use intended. No specific number or orientation of extended plastic posts is essential to the operation of the present invention.

Recess portion 107 of the storage and retrieval device is located laterally of post portion 105, and is configured in a unitary single molded construction for both the recess portion 107 and the post portion 105. Recess portion 107 comprises a large recess, reservoir or indentation 130 extending down into base 120 from upper base surface 122. Recess 130 is preferably deep enough to hold paper clips, coins, tokens, while still allowing sufficient thickness of the base 120 under the recess 130.

The surface of the recess 130 may be dimpled or textured to allow for easier pick up of small and/or flat items placed within recess 130. Additionally, a fillet may be integral with the recess 130 edges to also allow for easier pick up of small and/or flat items within recess 130 as the fillets would help push the items up when the items are slid towards and make contact with the fillets. Optionally, the storage and retrieval device may comprise lettering, symbols, or designs imprinted, embossed, debossed, or etched preferably along an outer edge of base 120 or along the lower surface of recess 130.

For illustrative purposes, FIG. 1 shows a paper clip resting in recess 130 to demonstrate the reservoir 130 on the device in use. The bottom base surface of the storage and retrieval device may have a magnetic or adhesive strip secured thereto, but magnetic or adhesive strips are not required for the use of the present invention. The magnetic and adhesive strip would allow the storage and retrieval device to be temporarily secured to a placement surface (surface upon which the storage and retrieval device is placed).

In one form of the invention, the material used for the extended plastic posts has a durometer between Shore A 45 and Shore A 60. A durometer of Shore A 60 has been found to be appropriate for the present invention. A high tear resistance is also preferred. Use of materials having a tear resistance over 100 P.l. is preferred. Having such a high tear resistance assists in providing a product wherein the extended plastic posts will not be torn or otherwise separated from the base when binder clip mechanisms, such as binder clips, are removed from the extended plastic posts.

The material used also should have a minimal compression set. A low compression set assures that the binder clip mechanisms do not leave compression indentions or marks on the extended plastic posts when binder clips are removed. Also, use of materials having a minimal compression set will provide extended plastic posts having resilience to retain their original shape even after being crimped or bent for long periods of time.

Although many materials will meet the requirements necessary to implementation of the present invention, plastic such as flexible thermoplastic polyurethane or polyvinyl chloride (PVC) as well as many rubbers will provide an appropriate material.

The steps in the manufacturing process include several steps. As Step 1, the plastic composition used to make the single molded unit should be mixed and combined thoroughly. The plastic composition must be thoroughly blended into a homogeneous mixture without separations of the material by settling or other means. This plastic composition is heated in a vessel over a low heat from 250-350° F. with frequent stirring or agitation. The plastic composition is a thermoplastic composition which changes its solidity characteristics with heat, but thermosetting plastic could also be used to set once upon heating and cooling. The plastic composition will become clear as it heats. Remove the vessel from the heat source with the plastic composition reaches 325-350° F.

The heat source can be a gas burner, electric heating element, or even a microwave oven. If the plastic composition is heated using a stove top or a melting pot, the mixture should be stirred constantly to prevent burning. Some heating pots may have an integrated heating element.

One can also use a microwave, but a safety measuring cup or safety glass/porcelain ware to heat the plastic composition. If you use a microwave, fill your measuring cup with about ½ cup of mixed liquid plastic. Heat for approximately 1 minute, and then stir the heated mixture. Apply another cycle of heat, and then stir again. Repeat until plastic becomes clear and thick (like syrup) Microwaves vary in power, we have found 1-3 minutes is average for this amount of soft plastic.

In step 2, the mixture should have coloring added to the base plastic mix. Coloring can be added into the hot plastic composition until the plastic has reached your desired color and shade. Coloring should be highly concentrated pigment and can color up to ½ gallon of plastic when mixed to a proper concentration. Coloring can be added with a dropper at this stage in the processing.

In Step 3, the colored plastic composition is injected or otherwise placed in the mold body. The plastic mixture can be placed in a glass measuring cup or fill container beforehand, if needed. Molds can be made of metal or clay, which are fabricated separately, and an impression of the storage and retrieval device is placed in the mold material. Storage and retrieval device molds can be one piece injection molds or two piece molds that produce three dimensional fully formed storage and retrieval devices. The molds are virtually unbreakable and feature built-in alignment pins for easy assembly.

An injector of the plastic material is used to force the hot plastic into the mold. Its reservoir is large enough to make several baits from one filling. Place the mold on the injector with the nozzle in the smaller injection gate of the mold. Holding the mold firmly with both hands, apply slow downward pressure until the soft plastic fills the mold and the overflow reservoir at the top of the mold. Two cavity molds need a short cooling period before filling the second cavity. Set the mold aside for a few seconds and fill another mold while you wait for the first cavity to cool.

You should have enough plastic to make approximately 20-30 storage and retrieval devices. The plastic composition will shrink as it cools, so one needs to make sure the overflow and fill reservoirs of the mold are full to the top when you inject the mold. Underfilling the mold can causes hollow devices, which is not desired. The liquid plastic composition is scorch resistant hot-melt plastic thermoplastic compositions that can be reheated, allowing you to reuse plastic scraps. A hardener can be added to make harder, tougher devices.

In the final step, one should remove the devices from the molds and place them in cool water until they have cooled completely. The devices in the molds are allowed to cool, and one can remove the mold from the injector and stand the mold upright. The soft plastic should be allowed to cool to a solid consistency. The amount of cooling time will vary based on the size of the device and number of mold cavities. After removal from the mold, one should allow the storage and retrieval devices to cool for three to five minutes.

Referring to FIG. 2A, different views of the embodiment in FIG. 1 is illustrated. Looking at FIG. 2A, the storage and retrieval device comprises a base 220, having an upper base surface 222 and a bottom base surface adjacent a placement surface (surface upon which the storage and retrieval device is placed), a post portion 205 and a recess portion 207. Base 220 is a planar shape. Post portion 205 has a plurality of extended plastic posts 224 that are integrally formed or attached to the upper base surface 222 and extend perpendicularly outward from upper base surface 222.

To provide additional strength, a fillet 232 may be integral with the device at the junction between the post base 226 and the base 220. Extended plastic posts 224 are positioned in a cluster format on base 220 and may be placed in rows and columns spaced such that the separation between rows and column are of relatively equal distance. This orientation is best viewed in the top view illustrated in FIG. 2A.

Although a preferred embodiment provides for the equal distance spacing of extended plastic posts 224, equal distance positioning of the extended plastic posts is not essential to the proper operation of the present invention. Moreover, the number of extended plastic posts may be increased or decreased to provide for sufficient storage of an appropriate number of binder clip mechanisms such that the storage device proves sufficient for the use intended. No specific number or orientation of extended plastic posts is essential to the operation of the present invention.

Recess portion 207 of the storage and retrieval device is located laterally of post portion 205, and is constructed from a single molded unitary structure that is used to produce the post portion 205 and recess portion 207. Recess portion 207 comprises a large reservoir, recess or indentation 203 extending down into base 220 from upper base surface 222. Recess 203 is preferably deep enough to keep paper clips, coins and tokens while still allowing for sufficient thickness of base 220 under the recess 203.

For illustrative purposes, FIGS. 2B and 2E show a binder clip attached to the extended plastic posts 224 to demonstrate the device in use. FIG. 2A is a top view of the storage and retrieval device shown in FIG. 1, FIG. 2B is a left side view of the storage and retrieval device shown in FIG. 1, FIG. 2C is an upside down view of side of the storage and retrieval device shown in FIG. 1, FIG. 2D is a front view of the storage and retrieval device shown in FIG. 1, and FIG. 2E is a rear view of the storage and retrieval device shown in FIG. 1.

For each of FIGS. 2B to 2E, the storage and retrieval device comprises a base 220, having an upper base surface 222 and a bottom base surface adjacent a placement surface (surface upon which the storage and retrieval device is placed), a post portion 205 and a recess portion 207. Base 220 is a planar shape. Post portion 205 has a plurality of extended plastic posts 224 that are integrally formed or attached to the upper base surface 222 and extend perpendicularly outward from upper base surface 222.

To provide additional strength, a fillet 232 may be integral with the device at the junction between the post base 226 and the base 220. Extended plastic posts 224 are positioned in a cluster format on base 220 and may be placed in rows and columns spaced such that the separation between rows and column are of relatively equal distance. This orientation is best viewed in the top view illustrated in FIG. 2A.

Although a preferred embodiment provides for the equal distance spacing of extended plastic posts 224, equal distance positioning of the extended plastic posts is not essential to the proper operation of the present invention. Moreover, the number of extended plastic posts may be increased or decreased to provide for sufficient storage of an appropriate number of binder clip mechanisms such that the storage device proves sufficient for the use intended. No specific number or orientation of extended plastic posts is essential to the operation of the present invention.

Recess portion 207 of the storage and retrieval device is located laterally of post portion 205, and is constructed from a single molded unitary structure that is used to produce the post portion 205 and recess portion 207. Recess portion 207 comprises a large reservoir, recess or indentation 203 extending down into base 220 from upper base surface 222. Recess 203 is preferably deep enough to keep paper clips, coins and tokens while still allowing for sufficient thickness of base 220 under the recess 203.

FIG. 3 shows a side view illustrating the extended plastic posts of an embodiment of the storage and retrieval device. Post portion 305 has a plurality of extended plastic posts 324 that are integrally formed or attached to the upper base surface 322 and extend perpendicularly outward from upper base surface 322. Extended plastic posts 324 are illustrated with a cylindrical post base 326, a slightly tapered post leg portion 328 extending from the base and terminating at the end opposite the base in a hemispherical post tip 329.

Support reinforcing ledge 334 is formed of the transition between post base 326 and post leg portion 328. Support reinforcing ledge 334 would be more commonly found when extended plastic posts 324 are attached to the upper base surface 322. Alternatively, especially when integrally formed, post base 326 and post leg portion 328 provide a continuous surface that does not have step 334.

To provide additional strength, a fillet 332 may be integral with the device at the junction between the post base 326 and the base 320. Extended plastic posts 324 are positioned in a cluster format on base 320 and may be placed in rows and columns spaced such that the separation between rows and column are of relatively equal distance.

Although a preferred embodiment provides for the equal distance spacing of extended plastic posts 324, equal distance positioning of the extended plastic posts is not essential to the proper operation of the present invention. Moreover, the number of extended plastic posts may be increased or decreased to provide for sufficient storage of an appropriate number of binder clip mechanisms such that the storage device proves sufficient for the use intended. No specific number or orientation of extended plastic posts is essential to the operation of the present invention.

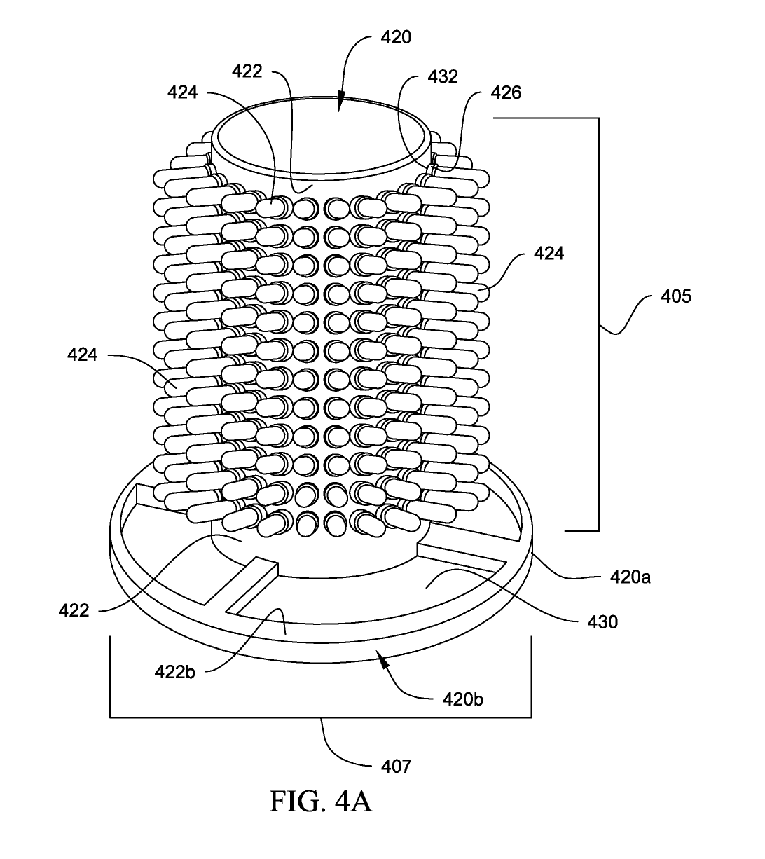

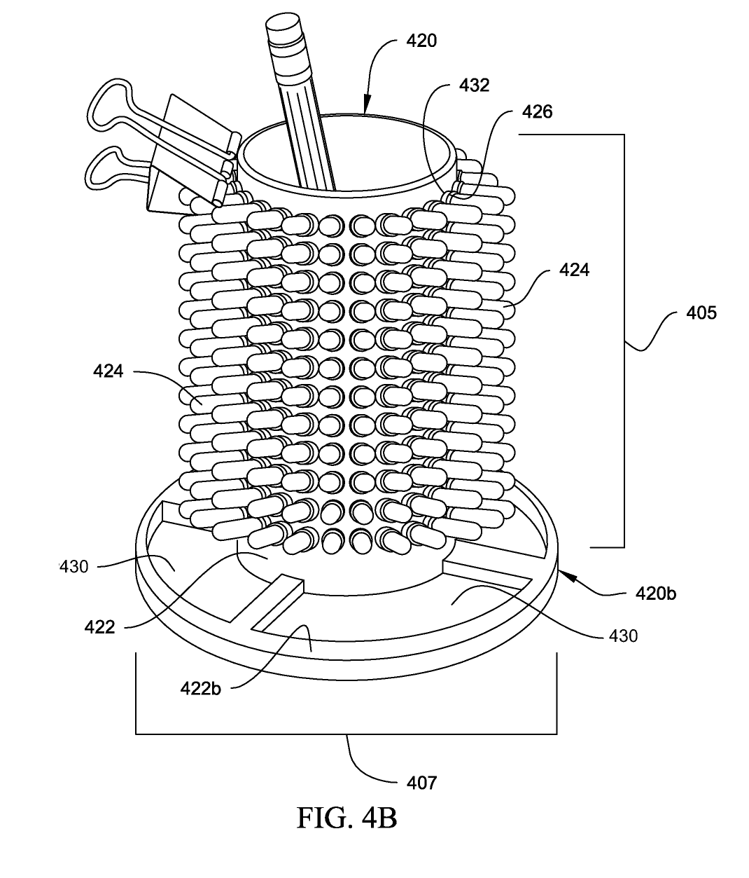

Referring to FIGS. 4A and 4B, an alternative layout of the storage and retrieval device is shown. The storage and retrieval device comprises a base 420A coupled to an outer base surface 422 and a post portion 405. Post portion 405 is formed in a cylindrical shape with a plurality of extended plastic posts 424 that are integrally formed or attached to the outer base surface 422 and extend outwardly from outer base surface 422.

To provide additional strength, a fillet 432 may be integral with the device at the junction between the post base 426 and the base 420. Extended plastic posts 424 are positioned in a cluster format on base 420 and may be placed in rows and columns spaced such that the separation between rows and column are of relatively equal distance.

Although a preferred embodiment provides for the equal distance spacing of extended plastic posts 424, equal distance positioning of the extended plastic posts is not essential to the proper operation of the present invention. Moreover, the number of extended plastic posts may be increased or decreased to provide for sufficient storage of an appropriate number of binder clip mechanisms such that the storage device proves sufficient for the use intended. No specific number or orientation of extended plastic posts is essential to the operation of the present invention.

Alternatively, post portion 405 may have a square, triangle, octagon, or other polygonal shape instead of a circular shape. As illustrated in FIGS. 4A and 4B, post portion 405 can also be a tube shape. The tube shape would allow for objects such as pens, pencils, markers, scissors, and the like to be maintained in the storage and retrieval device. For illustrative purposes, FIG. 4B shows a pencil resting inside post portion 405 and a binder clip clipped onto extended plastic posts 424 to demonstrate the tube-shaped embodiment of the device in use.

With post portion 405 in an upright position, recess portion 407 of the storage and retrieval device is located at a base 420A and 420b coupled to the bottom edge of the post portion 405. Recess portion 407 is integrally formed from or secured to this bottom edge and extends radially outward to an outer border forming recess portion base 420b. Recess portion base 420A and 420b has an upper base surface 422b and a bottom base surface adjacent a placement surface (surface upon which the storage and retrieval device is placed). This outer border as illustrated is circular, but may also be other shapes such as a square, triangle, octagon, or other polygonal shapes.

Recess portion 407 comprises a large recess or indentation 430 in FIGS. 4A and 130 in FIG. 4B extending down into recess portion base 420b from outer base surface 422. Recess 430 in 4A and 130 in FIG. 4B is preferably deep enough to keep paper clips, coins or tokens, while still being thick enough to allow for stability of base 420A and 420b under recess 430 in 4A and 130 in FIG. 4B. Preferably the outer border of the recess portion 407 is wide enough to provide stability to post portion 405, thus preventing post portion 405 from falling over.

Recess portion 407 may additionally comprise an attachment secured to the bottom base surface of the recess portion 407 that acts like a lazy Susan or any similar structure, as a shelf or tabletop, designed to revolve so that all the objects held within recess 430 in 4A and 130 in FIG. 4B or clipped to extended plastic posts 424 can be seen or reached easily.

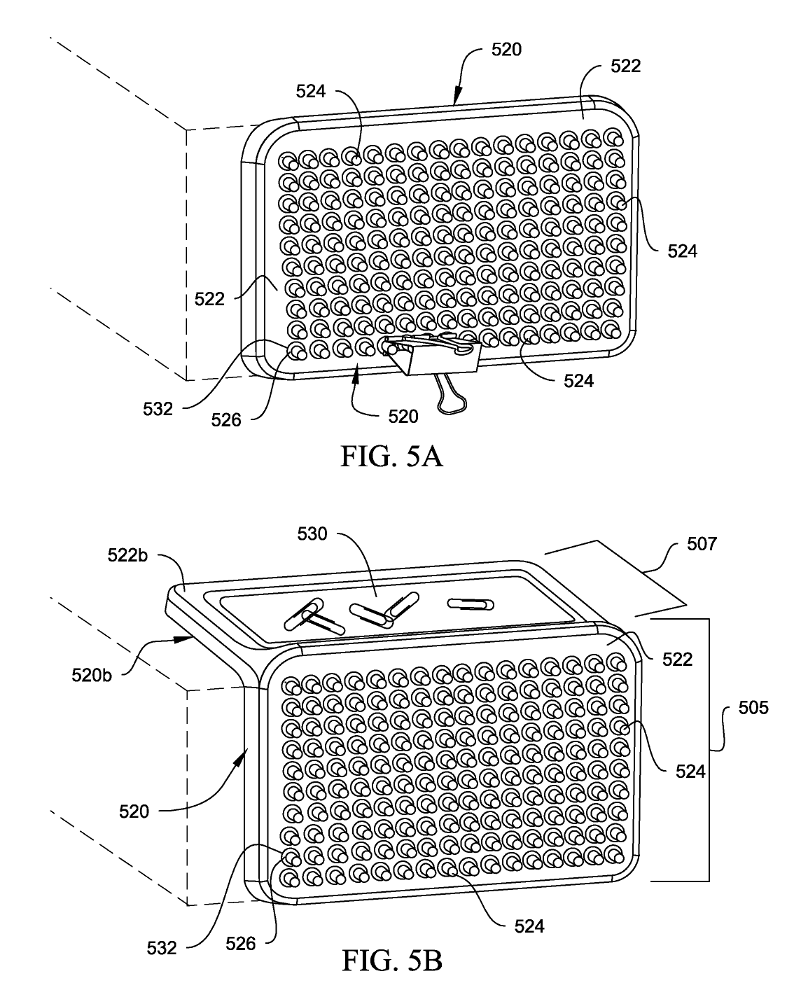

Referring to FIGS. 5A and 5B, an alternative layout of the storage and retrieval device is shown, which is most preferable for the edge of a table or desk. The storage and retrieval device comprises a base 520, having an outer base surface 522, an inner base surface adjacent a placement surface (surface upon which the storage and retrieval device is placed), and a post portion 505. Post portion 505 is a planar shape with a plurality of extended plastic posts 524 that are integrally formed or attached to the outer base surface 522 and extend outwardly from outer base surface 522.

To provide additional strength, a fillet 532 may be integral with the device at the junction between the post base 526 and the base 520. Extended plastic posts 524 are positioned in a cluster format on base 520 and may be placed in rows and columns spaced such that the separation between rows and column are of relatively equal distance.

Although a preferred embodiment provides for the equal distance spacing of extended plastic posts 524, equal distance positioning of the extended plastic posts is not essential to the proper operation of the present invention. Moreover, the number of extended plastic posts may be increased or decreased to provide for sufficient storage of an appropriate number of binder clip mechanisms such that the storage device proves sufficient for the use intended. No specific number or orientation of extended plastic posts is essential to the operation of the present invention.

Referring to FIG. 5B, the storage and retrieval device as described in FIG. 5A further comprises a recess portion 507. Recess portion 507 is integrally formed from or secured to an edge of post portion 505 in a single unitary molded construction and extends horizontally from the post portion 505 thereby forming recess portion base 520b. Recess portion base 520b has an upper base surface 522b and a bottom base surface adjacent a placement surface (surface upon which the storage and retrieval device is placed). Preferably recess portion base 520b is oriented with its bottom base surface downward. This outward border is illustrated in FIG. 5B as rectangular, but may be other shapes such as a circular, square, triangle, octagon, or other polygonal shapes.

Recess portion 507 comprises a large recess or indentation 530 extending down into recess portion base 520b from upper base surface 522b. Recess 530 is preferably deep enough to keep paper clips, coins and tokens, while allowing the base 520b to retain sufficient stability and thickness under recess 530. Recess portion 507 may also have a magnetic or adhesive strip secured to the bottom base surface of recess portion 507. For illustrative purposes, FIG. 5B shows a paper clip resting in recess 530 and a binder clip clipped onto extended plastic posts 524 to demonstrate the device in use.

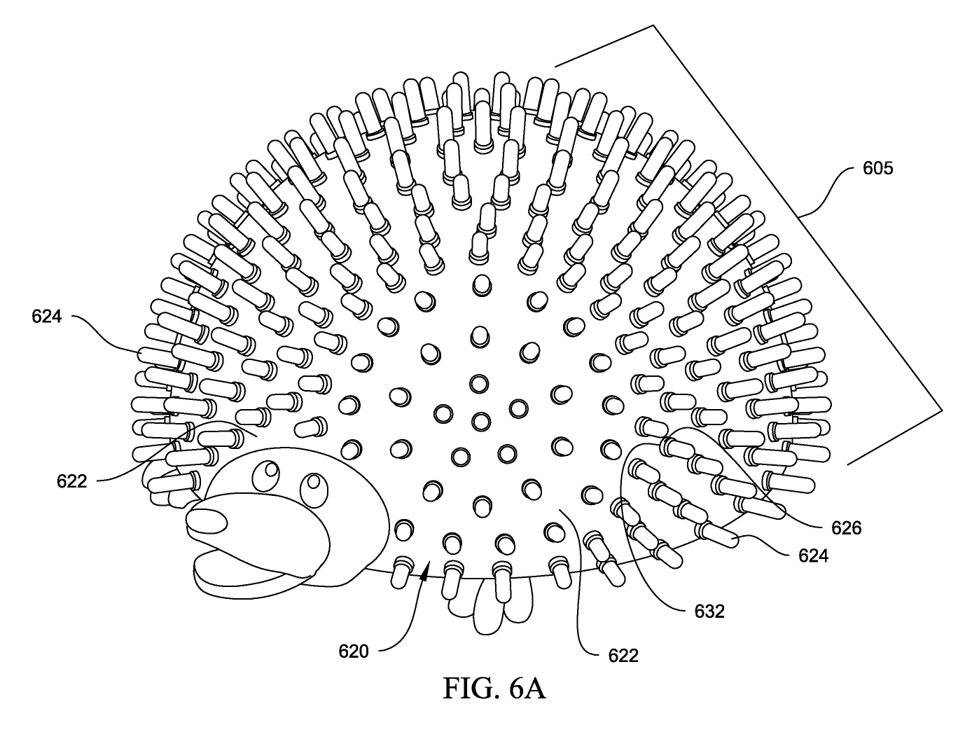

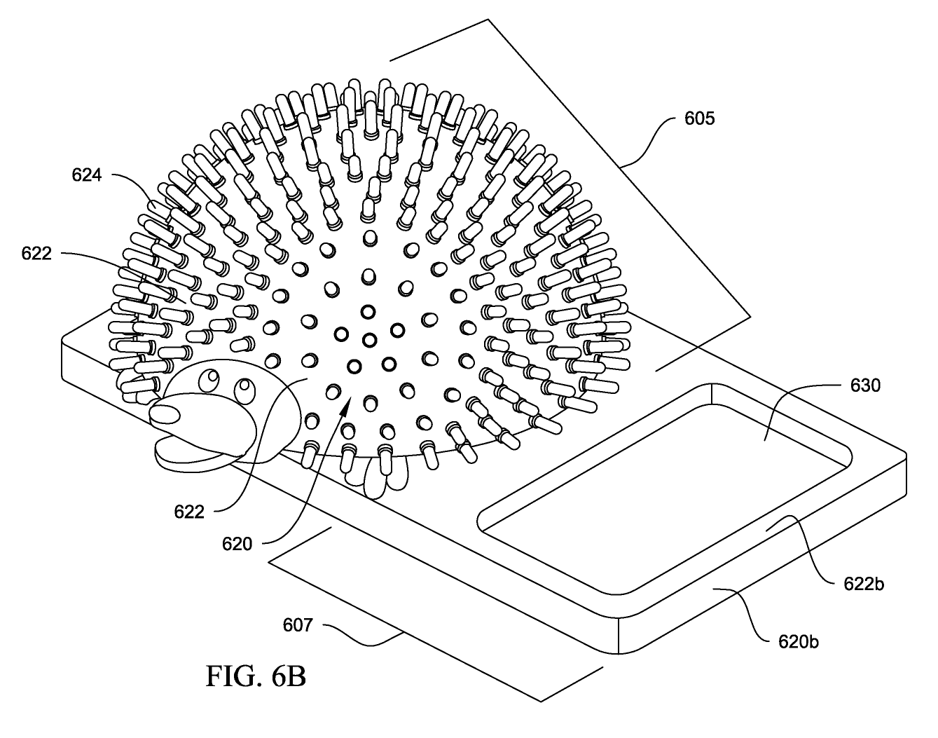

Referring to FIGS. 6A and 6B, the storage and retrieval device comprises a base 620, which takes on the shape similar to a hedgehog. Other animal or object shapes may also be used, for example, but not limited to, a porcupine, a cactus, a head. The device shown in FIGS. 6A and 6B have an outer surface 622, a bottom surface adjacent a placement surface (surface upon which the storage and retrieval device is placed), a post portion 605 and an optional recess portion 607 (shown in FIG. 6B). Base 620 shows the post portion 605 that has a plurality of extended plastic posts 624 that are integrally formed or attached to the upper base surface 622 and extend perpendicularly outward from upper base surface 622.

To provide additional strength, a fillet 632 may be integral with the device at the junction between the post base 626 and the base 620. Extended plastic posts 624 are positioned in a cluster format on base 620 and may be placed in rows and columns spaced such that the separation between rows and column are of relatively equal distance. Although a preferred embodiment provides for the equal distance spacing of extended plastic posts 624, equal distance positioning of the extended plastic posts is not essential to the proper operation of the present invention. Moreover, the number of extended plastic posts may be increased or decreased to provide for sufficient storage of an appropriate number of binder clip mechanisms such that the storage device proves sufficient for the use intended. No specific number or orientation of extended plastic posts is essential to the operation of the present invention.

Referring to FIG. 6B, the storage and retrieval device as described in FIG. 6A further comprises a recess portion 607. The optional recess portion 607 of the storage and retrieval device is located laterally of post portion 605 and formed of a unitary single molded construction with the recess portion 607. The recess portion 607 has an upper surface 622b and a bottom surface. As illustrated in FIG. 6B, recess portion 607 extends laterally from post portion 605 from the “feet” of the hedgehog creating recess portion base 620b.

Preferably recess portion 607 is adjacent to a placement surface (surface upon which the storage and retrieval device is placed) as that placement surface provides additional stability to the recess portion 607. The recess portion 607 may extend laterally to the side of base 626. The recess portion 607 may require a more rigid material or reinforcements applied to the recess portion 607, and recess portion 607 may also extend forward or rearward instead of laterally.

Alternatively, recess portion 607 may be integrated into a part of post portion 605 as illustrated in FIG. 6B. Although the recess portion 607 is integrated into the “head area” of the hedgehog, it may also be integrated into other areas of the post portion 605, for example the “back” or “rear” of the hedgehog.

Recess portion 607 comprises a large recess or indentation 630 extending down into base recess portion base 620b from upper surface 622b. Recess 630 is preferably deep enough to maintain paper clips, coins and tokens while still sufficiently thick to maintain stability of the base 620b under recess 630.

Referring again to FIGS. 6A and 6B, secured to the bottom surface of base 620 and/or the bottom surface of recess portion base 620b may be a magnetic or adhesive strip. This strip allows post portion 605 and/or recess portion 607 the ability to be temporarily attached to the placement surface.

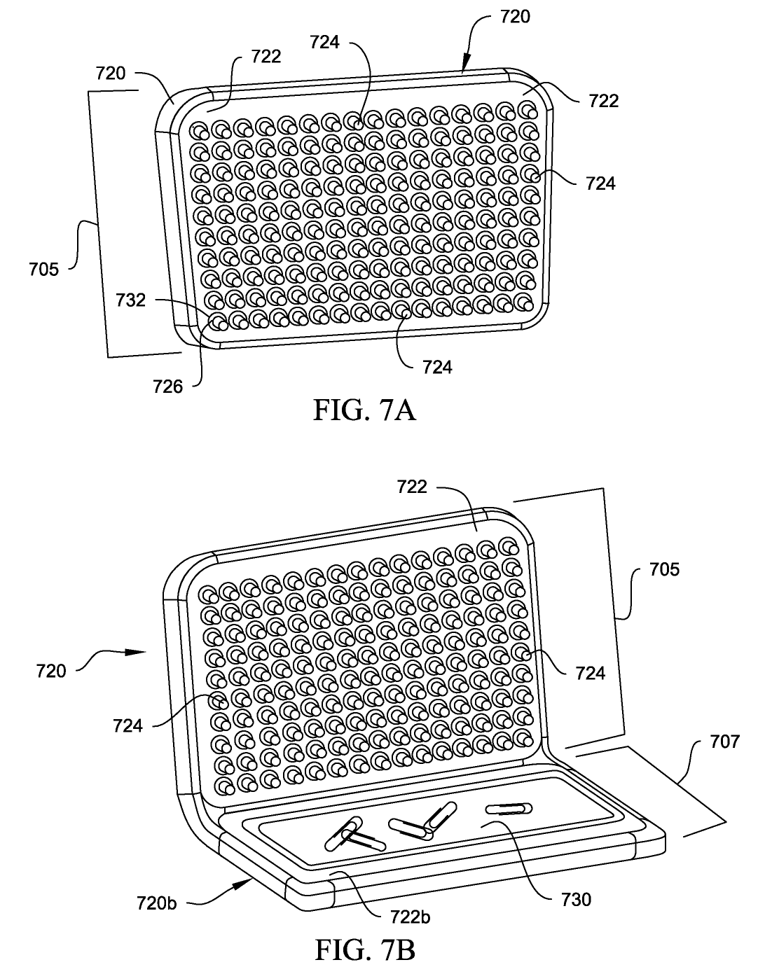

Referring to FIGS. 7A and 7B, another alternative layout of the storage and retrieval device is shown with a post portion 705 aligned vertically for placement along a vertical wall. The storage and retrieval device comprises a base 720, having an outer base surface 722, an inner base surface adjacent a placement surface (surface upon which the storage and retrieval device is placed), and a post portion 705. Post portion 705 is a planar shape with a plurality of extended plastic posts 724 that are integrally formed or attached to the outer base surface 722 and extending outwardly from outer base surface 722.

To provide additional strength, a fillet 732 may be integral with the device at the junction between the post base 726 and the base 720. Extended plastic posts 724 are positioned in a cluster format on base 720 and may be placed in rows and columns spaced such that the separation between rows and column are of relatively equal distance.

Although a preferred embodiment provides for the equal distance spacing of extended plastic posts 724, equal distance positioning of the extended plastic posts is not essential to the proper operation of the present invention. Moreover, the number of extended plastic posts may be increased or decreased to provide for sufficient storage of an appropriate number of binder clip mechanisms such that the storage device proves sufficient for the use intended. No specific number or orientation of extended plastic posts is essential to the operation of the present invention.

Referring to FIG. 7B, the storage and retrieval device as described in FIG. 7A further comprises a recess portion 707. Recess portion 707 is integrally formed from or secured to an edge of post portion 705 using a single unitary molded construction with the recess portion 707. The recess portion 707 extends outwardly to an outer border forming recess portion base 720b. Recess portion base 720b has an upper base surface 722b and a bottom base surface adjacent a placement surface (surface upon which the storage and retrieval device is placed). Preferably recess portion base 720b is oriented with its bottom base surface downward. This outward border is illustrated in FIG. 7B as rectangular, but may be other shapes such as a square, circular, triangle, octagon, or other polygonal shapes.

Recess portion 707 comprises a large recess or indentation 730 extending down into recess portion base 720b from upper base surface 722b. Recess 730 is preferably deep enough to keep binder clip mechanisms and allow their retrieval from the device. The recess thickness will still allow for stability within the thickness of base 720b along recess 730. Recess portion 707 may also have a magnetic or adhesive strip secured to the bottom base surface of recess portion 707.

For illustrative purposes, FIG. 7B shows a paper clip resting in recess 730 and a binder clip clipped onto extended plastic posts 724 to demonstrate the device in use. Referring to FIGS. 7A and 7B, secured to the inner base surface of base 720 or the bottom base surface of recess portion base 720b may be a magnetic or adhesive strip. This strip allows post portion 705 and/or recess portion 707 the ability to be temporarily attached to the placement surface. Alternatively, connectors may be secured to the inner base surface of base 720 that engage other connectors on the placement surface, for example loops secured to the inner base surface of base 720 that engage screws or hooks secured to a wall.

Optionally, the storage and retrieval device may comprise lettering, symbols, or designs imprinted, embossed, debossed, or etched on the device. This allows for personalization of the device or even advertisement.

The horizontal cross section of the extended plastic posts used may be circular as shown in the Figures, but alternative geometries may also be employed. For example, the horizontal cross section of the extended plastic posts may also be rectangular, square, octagonal, or any other geometric shape, so long as the thickness of the extended plastic posts and shape allow it to stand upright under normal conditions and to withstand the stress of being gripped by the binder clip mechanism without breaking, and so long as the extended plastic posts are of a sufficient length to permit easy gripping by the binder clip mechanism. Generally, the extended plastic posts are made of flexible material, but the need for, or degree of flexibility will depend upon the type of binder clip mechanism for which the particular storage device is designed.

Although preferred embodiments of the invention have been described in the foregoing Detailed Description and illustrated in the accompanying drawings, it will be understood that the invention is not limited to the embodiments disclosed, or the specific dimensions or materials discussed, but is capable of numerous arrangements, modifications and substitutions of parts and elements without departing from the spirit of the invention. Accordingly, the present invention is intended to encompass such rearrangements, modifications and substitutions as fall within the spirit and scope of the invention.

While preferred embodiments of the invention have been shown and described, modifications thereof can be made by one skilled in the art without departing from the spirit and teachings of the invention. The embodiments described herein are exemplary only, and are not intended to be limiting. Many variations and modifications of the invention disclosed herein are possible and are within the scope of the invention.

Having described the invention, I claim:

1. A storage and retrieval device for clip mechanisms, comprising:
a base having an upper base and an lower base on the opposing side of the base;
a post portion on the upper base portion and having extended posts that project outwardly from the upper base, said extended posts having a post body positioned to allow one or more binder clips to be positioned in a clasping orientation to the posts, the posts having a support fillet positioned between the extended post body and the base, said fillet surrounds each of said extended plastic posts to reinforce the structural strength of said post;
a recess portion coupled to the post portion and formed of a unitary molded plastic with the post portion, said recess portion horizontally oriented so that the recess portion holds items, said recess portion having sufficient depth to maintain an item while recess portion has sufficient thickness to maintain structural stability of the base under the recess portion.

2. The device of claim 1, wherein the posts have a support ring surrounding the lower portion of the post body.

3. The device of claim 1, wherein the posts have a hemispherical top.

4. The device of claim 1, wherein the storage and retrieval device forms the image of a hedgehog, porcupine, or other animal.

5. The device of claim 1, wherein the post portion is vertically oriented.

6. The device of claim 1, wherein the post portion is horizontally oriented.

7. The device of claim 1, wherein said plastic posts are made of flexible material.

8. A storage and retrieval device for clip mechanisms, comprising:
a base having an upper base and an lower base on the opposing side of the base;
a post portion on the upper base portion and having extended posts that project outwardly from the upper base, said extended posts having a post body positioned to allow one or more binder clips to be positioned in a clasping orientation to the posts;
a recess portion coupled to the post portion and horizontally oriented so that the recess portion holds items, said recess portion having sufficient depth to maintain an item while recess portion has sufficient thickness to maintain structural stability of the base under the recess portion.

9. The device of claim 8, wherein the posts have a support fillet positioned between the extended post body and the base, said fillet surrounds each of said extended plastic posts to reinforce the structural strength of said post.

10. The device of claim 8, wherein the posts have a support ring surrounding the lower portion of the post body.

11. The device of claim 8, wherein the posts have a hemispherical top.

12. The device of claim 8, wherein the post portion and the recess portion are formed by a unitary molded plastic.

13. The device of claim 8, wherein the storage and retrieval device forms the image of a hedgehog, porcupine, or other animal.

14. The device of claim 8, wherein the post portion is vertically oriented.

15. The device of claim 8, wherein the post portion is horizontally oriented.

16. The device of claim 8, wherein said plastic posts are made of flexible material.

17. A method of making a storage and retrieval device for clip mechanisms, comprising the steps of:
providing a base having an upper base and an lower base on the opposing side of the base;
providing the base with a post portion on the upper base portion and having extended posts that project outwardly from the upper base, said extended posts having a post body positioned to allow one or more binder clips to be positioned in a clasping orientation to the posts;
coupling a recess portion to the post portion and having said recess portion horizontally oriented so that the recess portion holds items, said recess portion having sufficient depth to maintain an item while recess portion has sufficient thickness to maintain structural stability of the base under the recess portion.

18. The method of claim 17, wherein the posts have a support fillet positioned between the extended post body and the base, said fillet surrounds each of said extended plastic posts to reinforce the structural strength of said post.

19. The method of claim 17, wherein the posts have a support ring surrounding the lower portion of the post body.

20. The method of claim 17, wherein the posts have a hemispherical top.

21. The method of claim 17, wherein the post portion and the recess portion are formed by a unitary molded plastic.

22. The method of claim 17, wherein the storage and retrieval device forms the image of a hedgehog, porcupine, or other animal.

23. The method of claim 17, wherein the post portion is vertically oriented.

24. The method of claim 17, wherein the post portion is horizontally oriented.

25. The method of claim 17, wherein said plastic posts are made of flexible material.
